(19) United States
(12) Patent Application Publication
(10) Pub. No.: US 2024/0195029 A1
(43) Pub. Date: Jun. 13, 2024

(54) POWER BATTERY COVER AND POWER BATTERY

(71) Applicant: Shenzhen Kedali Industry Co., Ltd., Guangdong (CN)

(72) Inventor: Jianju Li, Guangdong (CN)

(21) Appl. No.: 17/907,905

(22) PCT Filed: Sep. 16, 2021
(86) PCT No.: PCT/CN2021/118760

§ 371 Date: Aug. 29, 2022

(30) Foreign Application Priority Data
May 14, 2021 (CN) 202121031942.8

(51) Int. Cl. H01M 50/562; H01M 50/15; H01M 50/164; H01M 50/184; H01M 50/55; H01M 50/553; H01M 50/567

(52) U.S. Cl. CPC H01M 50/562; H01M 50/15; H01M 50/164; H01M 50/184; H01M 50/55; H01M 50/553; H01M 50/567

(57) ABSTRACT

The present application relates to the technical field of power batteries, and specifically discloses a power battery cover and a power battery. The power battery cover includes a copper-aluminum composite terminal, a top cover, a seal, an upper plastic insulator and a lower plastic insulator. The copper-aluminum composite terminal is disposed to pass through the top cover, the upper plastic insulator and the lower plastic insulator. The copper-aluminum composite terminal includes a copper base body part and an aluminum base body part connected to each other, and a composite connection surface is formed between the aluminum base body part and the copper base body part, and sealed and wrapped by the seal.

This application claims priority to Chinese Patent Application No. 202121031942.8 filed with the China National Intellectual Property Administration (CNIPA) on May 14, 2021, the disclosure of which is incorporated herein by reference in its entirety.

### TECHNICAL FIELD

The present application relates to the technical field of power batteries, and in particular, to a power battery cover and a power battery.

### BACKGROUND

In the technical field of power batteries, the terminal is a component that connects the inside and outside of a battery in a power battery cover. One end of the terminal is connected to the external circuit of the power battery, and another end of the terminal is connected to the internal battery cell of the power battery. The negative current collector inside the battery cell is made of copper foil, so that the negative terminal of the power battery cover can ensure the use performance of the internal battery cell of the battery only by adopting pure copper material, thus achieving the charge and discharge functions of the battery.

### SUMMARY

The embodiments of the present application provide a power battery cover and a power battery to deal with the risk of poor sealing effect of the sealing ring and easy failure of the power battery in the copper-aluminum composite terminal.

In a first aspect, the present application provides a power battery cover, which includes a top cover, a copper-aluminum composite terminal, a seal, an upper plastic insulator, and a lower plastic insulator. The copper-aluminum composite terminal is disposed to pass through the top cover. The copper-aluminum composite terminal includes a copper base body part and an aluminum base body part connected to each other, where the copper base body part includes a first base body part and a first column body part, the aluminum base body part includes a second column body part and a third column body part, a diameter of the second column body part is equal to a diameter of the first column body part, and an end surface of the first column body part and an end surface of the second column body part are connected to form a composite connection surface. The seal is clamped between the copper-aluminum composite terminal and the top cover, and the seal seals and wraps the composite connection surface. The upper plastic insulator is disposed above the top cover, and the copper-aluminum composite terminal is disposed to pass through the upper plastic insulator. The lower plastic insulator is disposed below the top cover and clamped between the top cover and the copper-aluminum composite terminal.

In a second aspect, the embodiments of the present application provide a power battery, including the power battery cover described above.

### BRIEF DESCRIPTION OF DRAWINGS

FIG. 1 is a schematic structural view of a power battery cover provided in an embodiment of the present application;

FIG. 2 is an exploded view of a power battery cover provided in an embodiment of the present application;

FIG. 3 is a left view of a power battery cover provided in an embodiment of the present application;

FIG. 4 is a schematic structural view of a seal provided in an embodiment of the present application; and

FIG. 5 is a partial cross-sectional view of A-A of FIG. 3.

In the drawings:

1, Copper-aluminum composite terminal; 11, Aluminum base body part; 112, Second column body part; 113, Third column body part; 12, Copper base body part; 120, First base body part; 121, First column body part; 2, Top cover; 3, Seal; 31, First sealing part; 32, Second sealing part; 33, Third sealing part; 4, Upper plastic insulator 5, Lower plastic insulator 6, Riveting block; 61, First step hole; 62, Second step hole; 63, Counter bore.

### DETAILED DESCRIPTION

In the related art, pure copper material has the disadvantages of heavy weight and high material cost. In order to overcome this disadvantage, a copper-aluminum composite terminal can be provided, and pure aluminum material is used to connect the external circuit of the power battery to deal with the heavy weight and high material cost of the negative terminal of pure copper material.

In the assembling method of the copper-aluminum composite terminal in the related art, the connecting surface of the copper-aluminum composite terminal is usually located above or below the sealing ring. This setting method cannot play a good sealing effect. Once the electrolyte penetrates and contacts the aluminum material of the copper-aluminum composite terminal, it will affect the performance of the cells in the power battery and cause the power battery to fail.

Therefore, there is an urgent need to provide a power battery cover and a power battery, which can reduce the weight and cost of the battery while ensuring the performance of the battery.

The embodiments of the present application disclose a power battery cover and a power battery, and the embodiments of the present application will be clearly and completely described below with reference to the accompanying drawings.

All other embodiments obtained by those of ordinary skill in the art based on the embodiments of the present application without requiring creative efforts shall all fall in the scope of protection of the present application.

In the description of the present application, it should be noted that orientations or position relations indicated by terms such as “center”, “upper”, “lower”, “left”, “right”, “vertical”, “horizontal”, “in” and “out” are based on the drawings. These orientations or position relations are intended only to facilitate and simplify the description of the present application and not to indicate or imply that a device or element referred to must have such particular orientations or must be configured or operated in such particular orientations. Moreover, terms such as “first” and “second” are used only for the purpose of description and are not to be construed as indicating or implying relative importance. Terms such as “first position” and “second position” are two different positions, and moreover, a first feature being “on”, “above” and “over” a second feature includes the first feature being directly above and obliquely above the second feature, or simply indicates that the first feature is at a higher level than the second feature. The first feature being “under”, “below” and “beneath” the second feature includes the first feature being directly below and obliquely below the second feature, or simply represents that the first feature is at a lower level than the second feature.

In the description of the present application, terms “mounted”. “joined” and “connected” are to be understood in a broad sense unless otherwise expressly specified and limited. For example, the term “connected” may refer to “securely connected” or “detachably connected” or “integrally connected”, may refer to “mechanically connected” or “electrically connected” or may refer to “connected directly”, “connected indirectly through an intermediary” or “connected inside two components”. For those of ordinary skill in the art, specific meanings of the preceding terms in the present application may be understood based on specific situations.

The embodiments of the present application are described in detail below; examples of which are illustrated in the accompanying drawings, in which same or similar reference numerals refer to the same or similar elements or elements having the same or similar functions throughout.

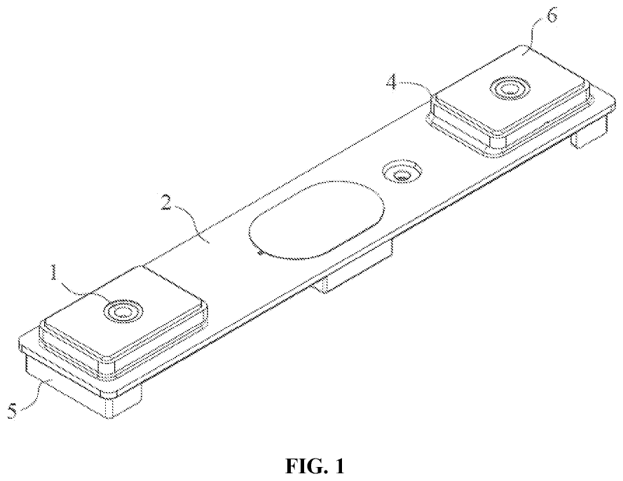

As shown in FIG. 1 to FIG. 3, this embodiment provides a power battery cover. The power battery cover includes a copper-aluminum composite terminal 1, a top cover 2, a seal 3, an upper plastic insulator 4 and a lower plastic insulator 5. The copper-aluminum composite terminal 1 is disposed to pass through the top cover 2, the upper plastic insulator 4 and the lower plastic insulator 5. The upper plastic insulator 4 is disposed above the top cover 2, the lower plastic insulator 5 is disposed below the top cover 2, and the lower plastic insulator 5 is clamped between the top cover 2 and the copper-aluminum composite terminal 1. The copper-aluminum composite terminal 1 includes an copper base body part 12 and an aluminum base body part 11 connected to each other, the copper base body part 12 is connected to a negative current collector inside a battery cell of a power battery, and the aluminum base body part 11 is connected to an external circuit of the power battery, whereby problems of heavy weight and high cost due to a fact that a pure copper material is adopted to a negative terminal in an existing power battery cover are overcome, and in a case where the use performance of the battery is ensured, the weight of the power battery is reduced, and meanwhile the cost is reduced.

In an embodiment, the copper base body part 12 includes a first base body part 120 and a first column body part 121, the aluminum base body part 11 includes a second column body part 112 and a third column body part 113, and a diameter of the second column body part 112 is equal to a diameter of the first column body part 112. A composite connection surface is formed between the aluminum base body part 11 and the copper base body part 12, the seal 3 is clamped between the copper-aluminum composite terminal 1 and the top cover 2, and the seal 3 seals and wraps the composite connection surface. Through such arrangement, the composite connection surface of the copper-aluminum composite terminal 1 may be sealed by the seal 3, so that the electrolyte is avoided from being in contact with an aluminum material in the copper-aluminum composite terminal 1, the performance of the battery cell of the power battery is avoided from being influenced, and thus the use reliability of the copper-aluminum composite terminal 1 is improved.

In an embodiment, the aluminum base body part 11 and copper base body part 12 may be connected by processes such as a friction welding or a riveting, and of course, other connection manners may also be adopted.

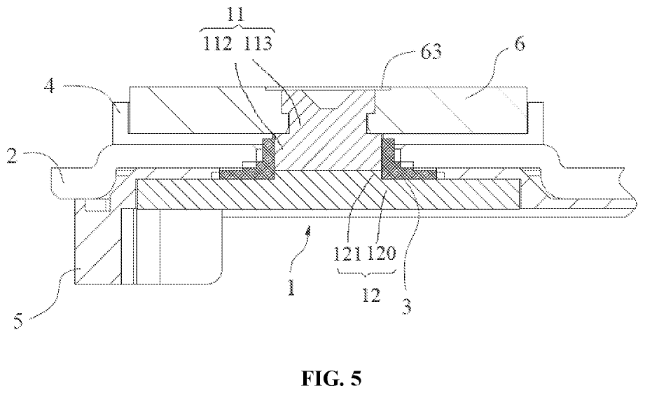

In an embodiment, as shown in FIG. 4 and FIG. 5, the seal 3 includes a cylindrical first sealing part 31; the first sealing part 31 is sleeved outside the copper-aluminum composite terminal 1 and is tightly attached to the copper-aluminum composite terminal 1. The first sealing part 31 seals and wraps the composite connection surface, so that the sealing effect of the seal 3 on the copper-aluminum composite terminal 1 is achieved, and due to a fact that the first sealing part 31 is of a cylindrical structure, a limiting effect on the copper-aluminum composite terminal 1 and a supporting effect on the upper plastic insulator 4 can be achieved, so that the composite connection surface of the copper-aluminum composite terminal 1 is protected from being dislocated in subsequent processing and using processes. Meanwhile, the seal 3 includes a ring-shaped second sealing part 32. A lower end surface of the second sealing part 32 is tightly attached to an upper end surface of the first base body part 120 of the copper base body part 12, and the upper end surface of the first base body part 120 of the copper base body part 12 is sealed by the second sealing part 32.

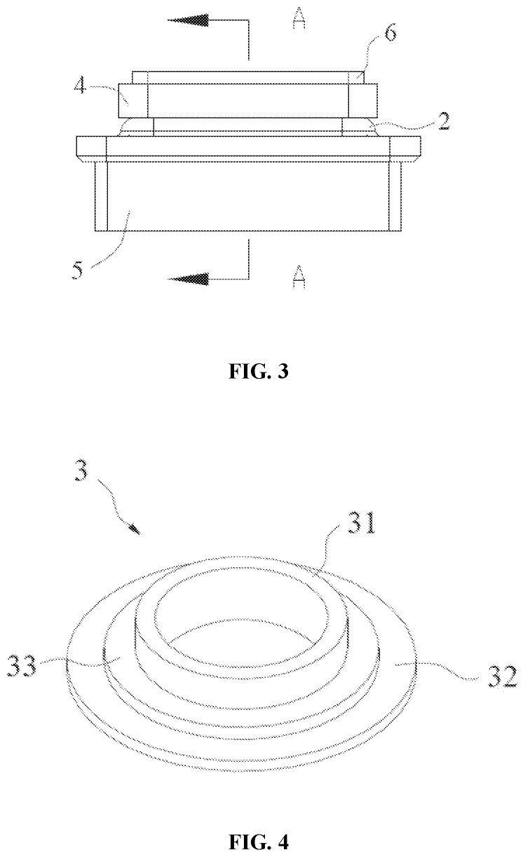

FIG. 5 is a partial cross-sectional view of A-A of FIG. 3, which is cut from the vertical direction of the structure shown in FIG. 3, and the observation direction is the direction of the arrow A.

In an embodiment, the first sealing part 31 is integrally formed with the second sealing part 32, and in this way, a machining process of the seal 3 can be simplified, and installation is facilitated.

In an embodiment, the seal 3 further includes a ring-shaped third sealing part 33. The ring-shaped third sealing part 33, when installed, due to the fluidity of the material, enables the seal 3 to discharge material to the surroundings when subjected to pressure until the required amount of compression is reached, whereby the sealing reliability of the seal 3 is improved.

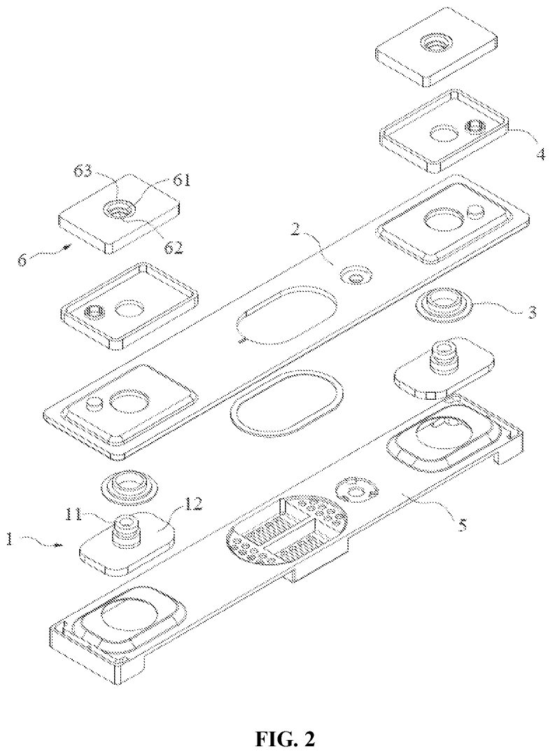

In an embodiment, the power battery cover in the embodiment fixes the copper-aluminum composite terminal 1 in a stamping manner, an upper end surface of the third column body part 113 is selected as a stamping surface, as shown in FIGS. 2 and 5. The power battery cover in this embodiment further includes a riveting block 6: the riveting block 6 is disposed above the upper plastic insulator 4. One end of the stamping surface of the third column body part 113 is disposed to pass through the riveting block 6, and meanwhile the riveting block 6 is provided with a first step hole 61 and a second step hole 62 which are connected and coaxially distributed. The third column body part 113 is disposed to pass through the first step hole 61.

In an embodiment, the riveting block 6 is further provided with a counter bore 63, and the counter bore 63 is connected to and coaxially disposed with the first step hole 61 and the second step hole 62. Through such arrangement, a riveting punch is convenient to impact downwards a punching end of the copper-aluminum composite terminal 1, so that an end of the third column body part 113 is formed with a protruding part protruding outwards, and the protruding part is snapped within the first step hole 61, so that the copper-aluminum composite terminal 1 is fixed, and the movement of the copper-aluminum composite terminal 1 along the axial direction of the copper-aluminum composite terminal 1 is limited.

In an embodiment, the upper plastic insulator 4 is provided with an accommodation groove, and the riveting block 6 may be placed within the an accommodation groove, so that an overall thickness of the power battery cover may be reduced, a larger installation space is vacated for the battery cell of the power battery, and an energy density of the power battery is improved.

In an embodiment, a containing cavity is formed on a side of the top cover 2 away from the upper plastic insulator 4, and can contain the copper base body part 12, and through such arrangement, the overall thickness of the power battery cover is reduced, and thus the energy density of the power battery continues to be improved.

This embodiment further provides a power battery including the power battery cover described above. In the power battery cover, the copper base body part 12 of the copper-aluminum composite terminal 1 is connected to a negative current collector inside a battery cell of the power battery, and the aluminum base body part 11 of the copper-aluminum composite terminal 1 is connected to an external circuit of the power battery, whereby in a case where the use performance of the battery is ensured, the weight of the power battery is reduced, and the cost is reduced.

What is claimed is:

1. A power battery cover, comprising:
a top cover;
a copper-aluminum composite terminal, wherein the copper-aluminum composite terminal is disposed to pass through the top cover, and the copper-aluminum composite terminal comprises a copper base body part and an aluminum base body part connected to each other, wherein the copper base body part comprises a first base body part and a first column body part, the aluminum base body part comprises a second column body part and a third column body part; a diameter of the second column body part is equal to a diameter of the first column body part, and an end surface of the first column body part and an end surface of the second column body part are connected to form a composite connection surface;
a seal, wherein the seal is clamped between the copper-aluminum composite terminal and the top cover, and the seal seals and wraps the composite connection surface;
an upper plastic insulator, wherein the upper plastic insulator is disposed above the top cover, and the copper-aluminum composite terminal is disposed to pass through the upper plastic insulator; and
a lower plastic insulator, wherein the lower plastic insulator is disposed below the top cover and clamped between the top cover and the copper-aluminum composite terminal.

2. The power battery cover of claim 1, wherein the seal comprises a cylindrical first sealing part; the first sealing part is sleeved outside the copper-aluminum composite terminal and is tightly attached to the copper-aluminum composite terminal, and the composite connection surface is sealed and wrapped by the first sealing part.

3. The power battery cover of claim 2, wherein the seal comprises a ring-shaped second sealing part connected to the first sealing part, and a lower end surface of the second sealing part is tightly attached to an upper end surface of the first base body part.

4. The power battery cover of claim 3, wherein the first sealing par is integrally formed with the second sealing part.

5. The power battery cover of claim 1, wherein the power battery cover fixes the copper-aluminum composite terminal in a stamping manner and a stamping surface is an upper end surface of the third column body part.

6. The power battery cover of claim 5, wherein the power battery cover comprises a riveting block, wherein the riveting block is disposed above the upper plastic insulator, and an end of the stamping surface of the third column body part is disposed to pass through the riveting block.

7. The power battery cover of claim 6, wherein the riveting block is provided with a first step hole and a second step hole which are connected and coaxially distributed, and wherein the third column body part is disposed to pass through the first step hole, an end of the third column body part is formed with a protruding part protruding outwards, and the protruding part is snapped within the first step hole.

8. The power battery cover of claim 7, wherein the riveting block is provided with a counter bore, wherein the counter bore is connected and coaxially disposed with the first step hole and the second step hole.

9. The power battery cover of claim 6, wherein the upper plastic insulator is provided with an accommodation groove, and the riveting block (6) is placed within the accommodation groove.

10. A power battery, comprising a power battery cover, wherein the power battery cover comprises:
a top cover;
a copper-aluminum composite terminal, wherein the copper-aluminum composite terminal is disposed to pass through the top cover, and the copper-aluminum composite terminal comprises a copper base body part and an aluminum base body part connected to each other, wherein the copper base body part comprises a first base body part and a first column body part, the aluminum base body part comprises a second column body part and a third column body part; a diameter of the second column body part is equal to a diameter of the first column body part, and an end surface of the first column body part and an end surface of the second column body part are connected to form a composite connection surface;
a seal, wherein the seal is clamped between the copper-aluminum composite terminal and the top cover, and the seal seals and wraps the composite connection surface;
an upper plastic insulator, wherein the upper plastic insulator is disposed above the top cover, and the copper-aluminum composite terminal is disposed to pass through the upper plastic insulator; and
a lower plastic insulator, wherein the lower plastic insulator is disposed below the top cover and clamped between the top cover and the copper-aluminum composite terminal.

11. The power battery cover of claim 2, wherein the power battery cover fixes the copper-aluminum composite terminal in a stamping manner and a stamping surface is an upper end surface of the third column body part.

12. The power battery cover of claim 3, wherein the power battery cover fixes the copper-aluminum composite terminal in a stamping manner and a stamping surface is an upper end surface of the third column body part.

14. The power battery cover of claim 4, wherein the power battery cover fixes the copper-aluminum composite terminal in a stamping manner and a stamping surface is an upper end surface of the third column body part.

15. The power battery of claim 10, wherein the seal comprises a cylindrical first sealing part; the first sealing part is sleeved outside the copper-aluminum composite terminal and is tightly attached to the copper-aluminum composite terminal, and the composite connection surface is sealed and wrapped by the first sealing part.

16. The power battery of claim 15, wherein the seal comprises a ring-shaped second sealing part connected to the first sealing part, and a lower end surface of the second sealing part is tightly attached to an upper end surface of the first base body part.

17. The power battery of claim 16, wherein the first sealing part is integrally formed with the second sealing part.

18. The power battery of claim 10, wherein the power battery cover fixes the copper-aluminum composite terminal in a stamping manner and a stamping surface is an upper end surface of the third column body part.

19. The power battery of claim 18, wherein the power battery cover comprises a riveting block, wherein the riveting block is disposed above the upper plastic insulator, and an end of the stamping surface of the third column body part is disposed to pass through the riveting block.

20. The power battery of claim 19, wherein the riveting block is provided with a first step hole and a second step hole which are connected and coaxially distributed, and wherein the third column body part is disposed to pass through the first step hole, an end of the third column body part is formed with a protruding part protruding outwards, and the protruding part is snapped within the first step hole.
